(19) United States
(12) Patent Application Publication
(10) Pub. No.: US 2013/0076524 A1
(43) Pub. Date: Mar. 28, 2013

(54) EARTHQUAKE ALARM

(71) Applicant: I-Hao HO, KAOHSIUNG CITY (TW)

(72) Inventor: I-Hao HO, KAOHSIUNG CITY (TW)

(21) Appl. No.: 13/239,944

(22) Filed: Sep. 22, 2011

(51) Int. Cl. G08B 21/10

(52) U.S. Cl. 340/690

(57) ABSTRACT

An earthquake alarm has a casing, a P-wave detecting device and an S-wave detecting device. The casing has a power supply, a controlling unit and a sound alarming unit. The controlling unit is electrically connected with the power supply. The sound alarming unit is electrically connected with the controlling unit. The P-wave detecting device has a longitudinally moving element and a contacting tab. The longitudinally moving element has a first end connected securely to the casing and a second end movable relative to the casing along a longitudinal direction. The contacting tab is spaced from and selectively contacting with the second end of the longitudinally moving element and is electrically connected with the controlling unit. The S-wave detecting device has a pendulum hung in the casing and a contacting ring. The contacting ring is mounted around the pendulum and is electrically connected with the controlling unit.

### BACKGROUND OF THE INVENTION

1. Field of the Invention

The present invention relates to an earthquake alarm, and more particularly to an earthquake alarm that can detect body waves of an earthquake.

2. Description of Related Art

Earthquakes always occur in the countries that are located on Circum-Pacific seismic belt, such as Taiwan. To reduce the damage caused by earthquakes, an earthquake alarm is provided to alarm people while an earthquake occurs.

In addition, earthquake waves occur during an earthquake and include body waves and surface waves. The body waves include P-waves (primary wave) and S-waves (secondary wave) having a transmitting speed lower than that of the P-wave but higher than that of the surface waves. The conventional earthquake alarm can detect the earthquake waves to send an alarm single.

However, the conventional earthquake alarm can only detect the S-wave, and the surface waves will come soon after the S-wave. Therefore, the period between the alarm single and the surface waves is too short to take refuge.

To overcome the shortcomings, the present invention tends to provide an earthquake alarm to mitigate or obviate the aforementioned problems.

### SUMMARY OF THE INVENTION

The main objective of the invention is to provide an earthquake alarm to prolong the time for taking refuge.

The earthquake alarm has a casing, a P-wave detecting device and an S-wave detecting device. The casing has an inner space defined in the casing, a power supply, a controlling unit and a sound alarming unit. The power supply is mounted in the casing. The controlling unit is mounted in the casing and is electrically connected with the power supply. The sound alarming unit is mounted in the casing and is electrically connected with the controlling unit. The P-wave detecting device is mounted in the casing and has a longitudinally moving element and a contacting tab. The longitudinally moving element is mounted in the casing and has a first end connected securely to the casing and a second end movable relative to the casing along a longitudinal direction. The contacting tab is mounted in the casing, is spaced from and selectively contacting with the second end of the longitudinally moving element and is electrically connected with the controlling unit. The S-wave detecting device is mounted in the casing and has a pendulum hung in the casing and a contacting ring. The contacting ring is mounted around the pendulum and is electrically connected with the controlling unit.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an earthquake alarm with a clock assembly in accordance with the present invention;

FIG. 2 is an exploded perspective view of the earthquake alarm in FIG. 1;

FIG. 3 is an enlarged operational front view of the earthquake alarm in FIG. 1 with the cover being removed and showing the operation of the P-wave detecting device;

FIG. 4 is an enlarged operational front view of the earthquake alarm in FIG. 1 with the cover being removed and showing the operation of the S-wave detecting device;

FIG. 5 is an enlarged operational front view of the earthquake alarm in FIG. 1 with the cover being removed and showing the S-wave detecting device being adjusted; and

FIG. 6 is a block diagram of the electrical connection of the earthquake alarm in FIG. 1.

### DETAILED DESCRIPTION OF PREFERRED EMBODIMENT

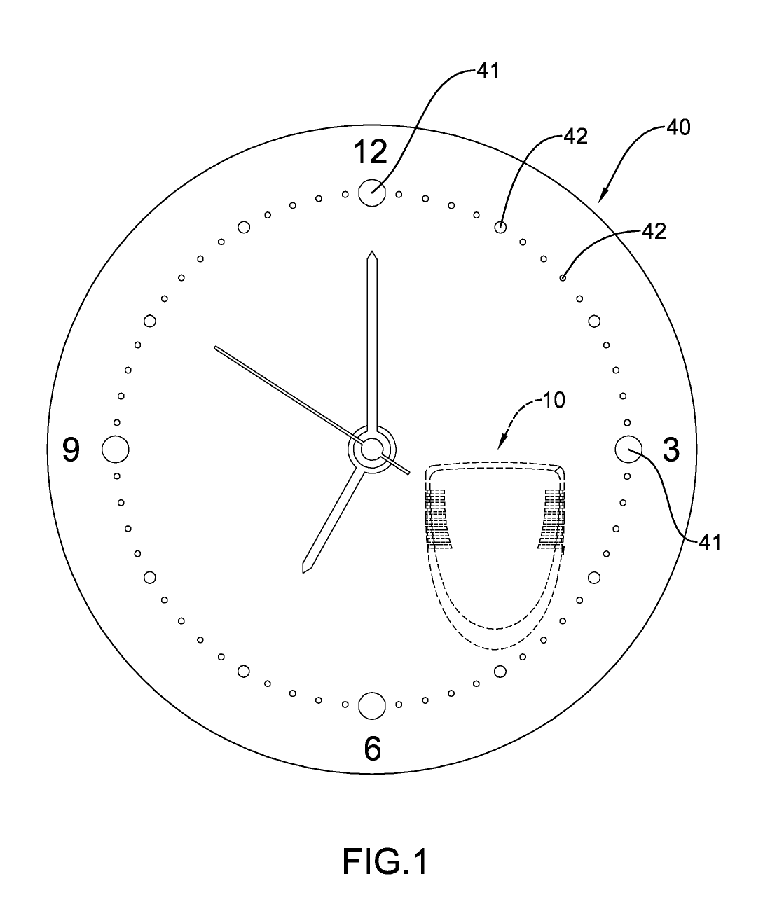

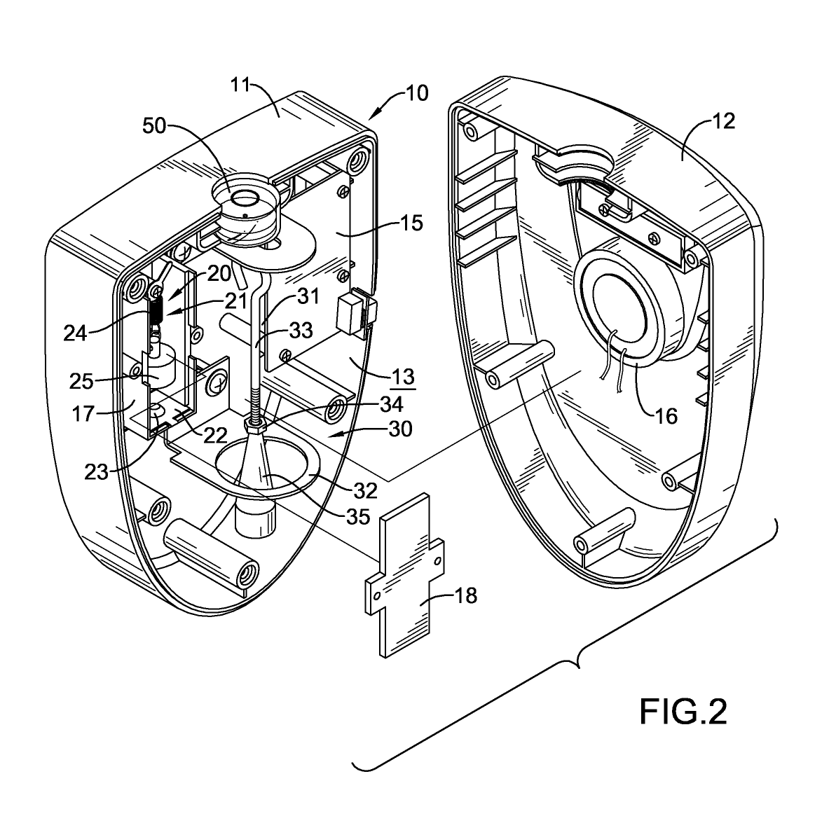

With reference to FIGS. 1 and 2, an earthquake alarm in accordance with the present invention comprises a casing 10, a P-wave detecting device 20, an S-wave detecting device 30 and a clock assembly 40.

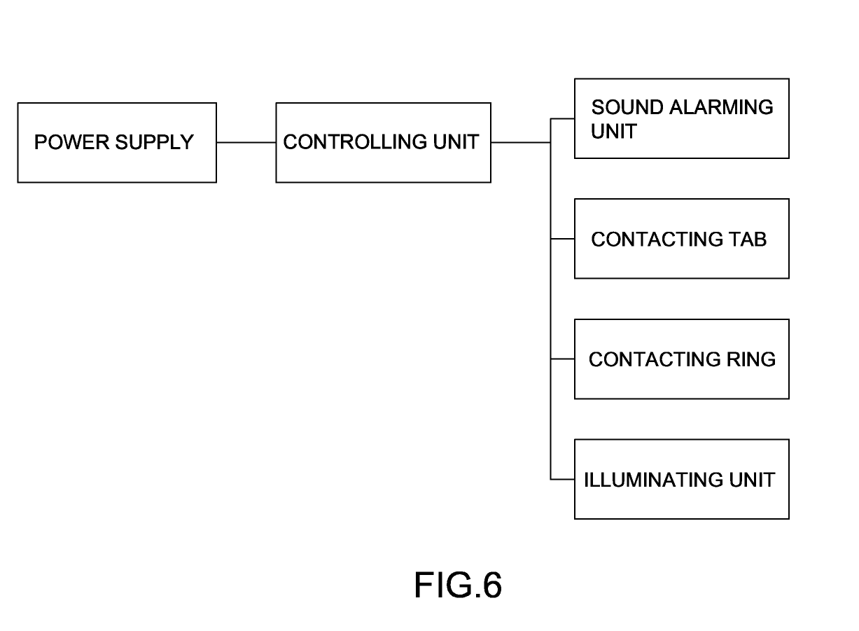

The casing 10 has an inner space 13 defined in the casing 10 and comprises a power supply 14, a controlling unit 15 and a sound alarming unit 16. The power supply 14 is mounted in the casing 10 and may be a battery assembly. With further reference to FIG. 6, the controlling unit 15 is mounted in the casing 10 and is electrically connected with the power supply 14. The sound alarming unit 16 is mounted in the casing 10 and is electrically connected with the controlling unit 15. Preferably, the casing 10 is composed of a base 11 and a cover 12 combined with each other. The power supply 14, the controlling unit 15, the P-wave detecting device 20 and the S-wave detecting device 30 are mounted in the base 11. The sound alarming unit 16 is mounted in the cover 12. In addition, the base 11 has a baffle 17 defining a receiving space in the baffle 17 and a lid 18 mounted on the baffle 17 to close the receiving space.

The P-wave detecting device 20 is mounted in the casing 10, is preferably mounted in the receiving space in the baffle 17 of the base 11 and comprises a longitudinally moving element 21 and a contacting tab 22. The longitudinally moving element 21 is mounted in the casing 10 and has a first end connected securely to the casing 10 and a second end movable relative to the casing 10 along a longitudinal direction. Preferably, the longitudinally moving element 21 is mounted in the receiving space and comprises a spring 24 and a weight 25. The spring 24 is mounted in the receiving space and has a first end securely connected to the base 11 and a second end. The weight 25 is mounted in the receiving space and is connected to the second end of the spring 24. The contacting tab 22 is mounted in the casing 10, is spaced from and selectively contacts with the second end of the longitudinally moving element 21 and is electrically connected with the controlling unit 15. Preferably, the contacting tab 22 is mounted on an inner wall of the baffle 17, is mounted in the receiving space and has a boss 23 formed on and protruding from the contacting tab 22 and selectively contacting with the weight 25.

The S-wave detecting device 30 is mounted in the casing 10, is preferably mounted in the base 11 and comprises a pendulum 31 and a contacting ring 32. The pendulum 31 is hung in the casing 10 and comprises a hook rod 33, a limiting element 34 and a contacting head 35. The hook rod 33 is hung in the base 11 and has a first end hung on the base 11 and a second end provided with an outer thread. The limiting element 34 may be a nut and is screwed with the outer thread on the hook rod 33. The contacting head 35 is connected to the second end of the hook rod 33 and has a connecting end and a free end. The connecting end is connected to the second end of the hook rod 33 and is adjacent to the limiting element 34. The free end is opposite to the limiting element 34. The connecting end has a diameter smaller than that of the free end. The contacting ring 32 is mounted around the pendulum 31 and is electrically connected with the controlling unit 15.

The clock assembly 40 has a time displaying surface, a mounting segment and an illuminating unit. The time displaying surface has multiple positions corresponding respectively to 1 to 12 o'clock. The mounting segment is formed on the time displaying surface, and the casing 10 is mounted on the mounting segment. The illuminating unit is mounted on the time displaying surface and is electrically connected with the controlling unit 15. Preferably, the illuminating unit comprises multiple alarming lights 41 mounted on positions on the time displaying surface referring respectively to 3, 6, 9 and 12 o'clock and multiple illuminating lights 42 mounted between the alarming lights 41.

In addition, a level 50 is mounted on the casing 10 and preferably is a bubble type level.

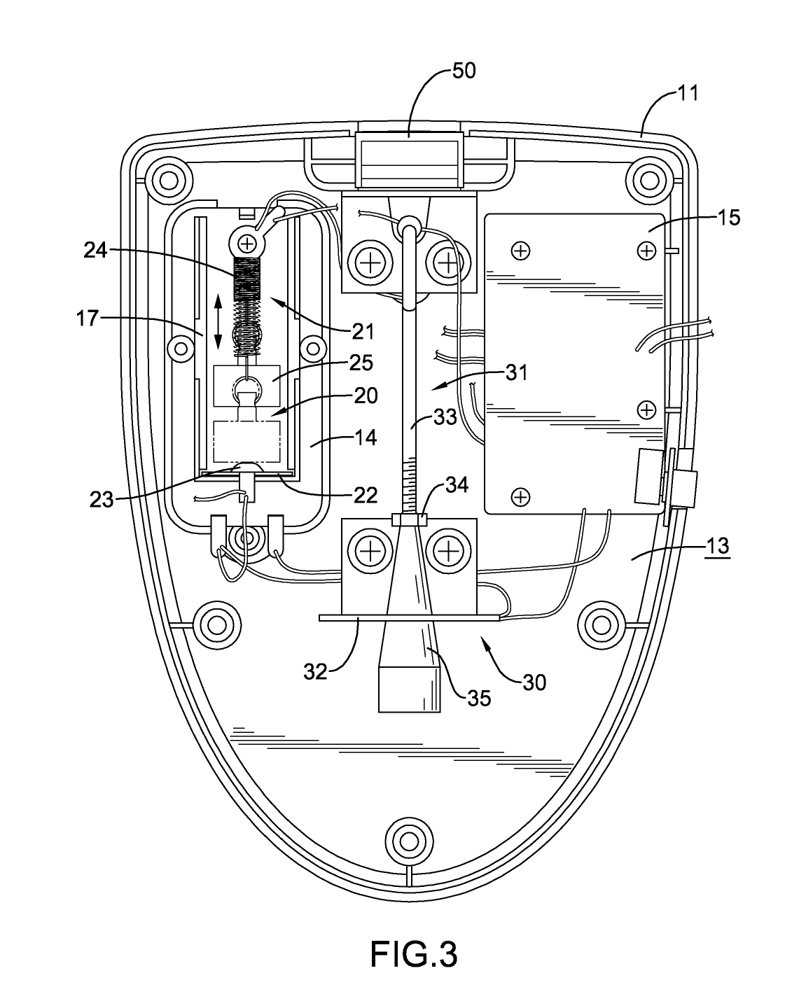

With reference to FIG. 3, when an earthquake occurs, the P-waves generated by the earthquake will be earliest transmitted to the location where the earthquake alarm is mounted. Thus, the weight 25 of the P-wave detecting device 20 will move upward and downward due to the P-waves. When the weight 25 moves to abut with the boss 23 of the contacting tab 22 due to the increase of the strength of the P-waves, the contacting tab 22 will send a single to the controlling unit 15. Then, the controlling unit 15 will control the sound alarming unit 16 to sound and the alarming lights 41 to light so as to provide dual alarming effects to people. At this time, the illuminating lights 42 are also lighted up to provide an illuminating effect to the people.

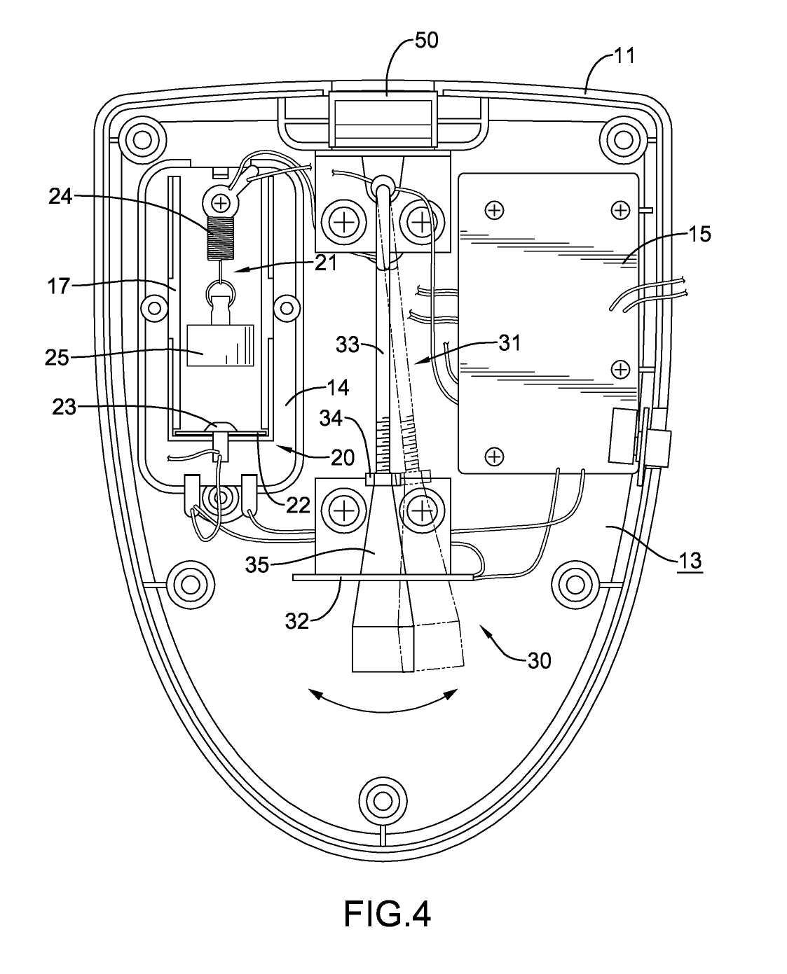

With reference to FIG. 4, when the S-waves achieves after the P-waves, the pendulum 31 of the S-wave detecting device 30 will swing due to the S-waves and will abut with the contacting ring 32 with the increase of the strength of the S-waves. With the contact of the pendulum 31 with the contacting ring 32, the contacting ring 32 will send a single to the controlling unit 15 and the sound alarming unit 16 and the illuminating unit will be actuated to sound or light. In practice, the sound and light generated by the sound alarming unit 16 and the alarming lights 41 for the P-waves may be different from those for the S-waves. The alarming lights 41 can be completely lighted up or flashed to provide different alarming effects. In addition, the illuminating lights 42 can provide an auxiliary alarming effect in cooperation with the alarming lights 41.

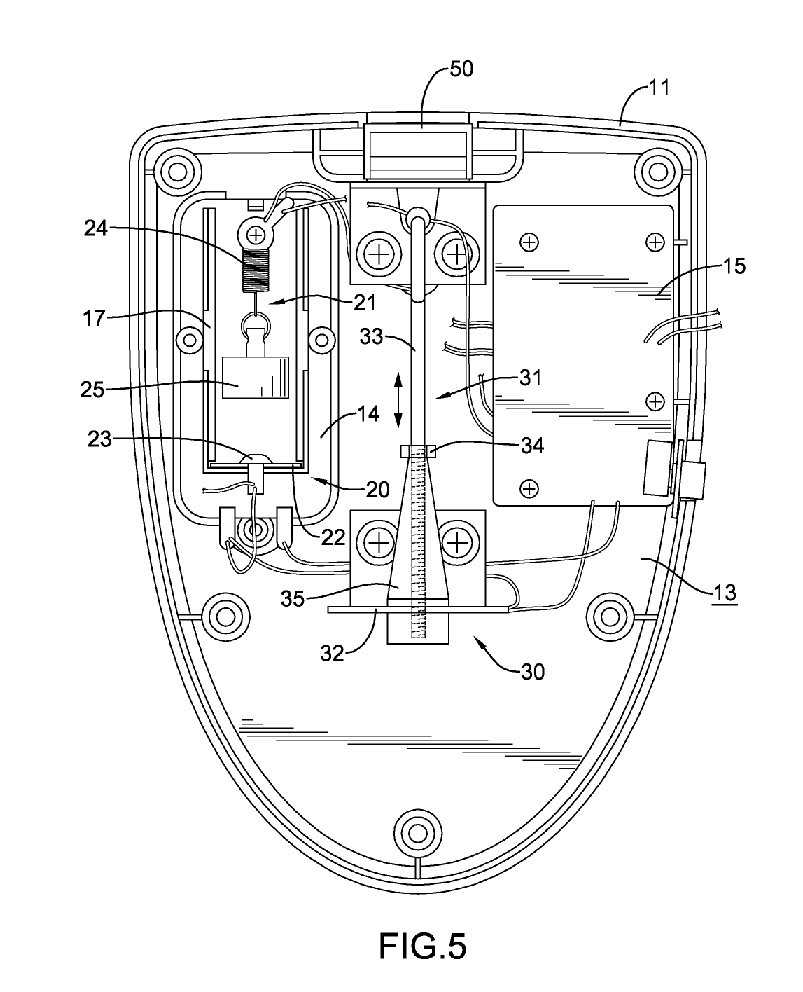

With reference to FIG. 5, when the contacting head 35 of the pendulum 31 is moved upward relative to the hook rod 33, a segment of the contacting head 35 in a larger diameter is moved to correspond to the contacting ring 32. Consequently, the swing travel of the pendulum 31 for contacting with the contacting ring 32 will be reduced, such that the sensitivity of the S-wave detecting device 30 for detecting the S-waves can be improved. On the contrary, if the contacting head 35 is moved downward relative to the hook rod 33, the swing travel of the pendulum 31 for contacting with the contacting ring 32 will be increased. Thus, the pendulum 31 will contact with the contacting ring 32 with larger S-waves.

In addition, the S-wave detecting device 30 can be determined whether the S-wave being arranged obliquely or not by the level 50 on the casing 10. With the arrangement of the level 50, the arranged angle of the earthquake alarm can also be determined.

Accordingly, the earthquake alarm in accordance with the present invention has capabilities of detecting the P-waves and S-waves and providing immediate alarming effect to people so as to provide sufficient period for taking refuge. When the S-wave detecting device 30 detects the S-waves, an additional alarming is provided to ensure the occurrence of the earthquake.

Furthermore, the clock assembly 40 cannot only provide telling time effect but also can provide an effect of that to ensure the earthquake alarm to be in a standby condition. When the clock assembly 40 stops operating, this means that the power of the earthquake alarm is used up. Consequently, the power supply 14 can be replaced or recharged immediately to enable the earthquake alarm to be operated normally. Furthermore, the level 50 can keep the earthquake alarm from being arranged obliquely to improve the accuracy of the earthquake alarm.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An earthquake alarm comprising:
a casing having
an inner space defined in the casing;
a power supply mounted in the casing;
a controlling unit mounted in the casing and electrically connected with the power supply; and
a sound alarming unit mounted in the casing and electrically connected with the controlling unit;
a P-wave detecting device mounted in the casing and comprising
a longitudinally moving element mounted in the casing and having
a first end connected securely to the casing; and
a second end movable relative to the casing along a longitudinal direction; and
a contacting tab mounted in the casing, spaced from and selectively contacting with the second end of the longitudinally moving element and electrically connected with the controlling unit; and
an S-wave detecting device mounted in the casing and comprising
a pendulum hung in the casing; and
a contacting ring mounted around the pendulum and electrically connected with the controlling unit.

2. The earthquake alarm as claimed in claim 1 further comprising a clock assembly having
a time displaying surface;
a mounting segment formed on the time displaying surface, wherein the casing is mounted on the mounting segment; and
an illuminating unit mounted on the time displaying surface and electrically connected with the controlling unit.

3. The earthquake alarm as claimed in claim 2, wherein illuminating unit comprises multiple alarming lights mounted on positions on the time displaying surface referring respectively to 3, 6, 9 and 12 o'clock and multiple illuminating lights mounted between the alarming lights.

4. The earthquake alarm as claimed in claim 3, wherein the casing further has a level mounted on the casing.

5. The earthquake alarm as claimed in claim 4, wherein the level is a bubble type level.

6. The earthquake alarm as claimed in claim 5, wherein the casing comprises a base and a cover combined with each other;
the power supply, the controlling unit, the P-wave detecting device and the S-wave detecting device are mounted in the base; and
the sound alarming unit is mounted in the cover.

7. The earthquake alarm as claimed in claim 6, wherein the base has a baffle defining a receiving space in the baffle and a lid mounted on the baffle to close the receiving space;
the longitudinally moving element of the P-wave detecting device is mounted in the receiving space and comprises
a spring mounted in the receiving space and having a first end securely connected to the base and a second end; and
a weight mounted in the receiving space and connected to the second end of the spring; and
the contacting tab is mounted on an inner wall of the baffle, is mounted in the receiving space and has a boss formed on and protruding from the contacting tab and selectively contacting with the weight.

8. The earthquake alarm as claimed in claim 7, wherein the pendulum has
a hook rod having a first end hung on the base and a second end provided with an outer thread;
a limiting element screwed with the outer thread on the hook rod; and
a contacting head having a connecting end connected to the second end of the hook rod and being adjacent to the limiting element and a free end opposite to the limiting element, wherein the connecting end has a diameter smaller than that of the free end.

9. The earthquake alarm as claimed in claim 1, wherein the casing further has a level mounted on the casing.

10. The earthquake alarm as claimed in claim 9, wherein the level is a bubble type level.

11. The earthquake alarm as claimed in claim 1, wherein the casing comprises a base and a cover combined with each other;
the power supply, the controlling unit, the P-wave detecting device and the S-wave detecting device are mounted in the base; and
the sound alarming unit is mounted in the cover.

12. The earthquake alarm as claimed in claim 11, wherein the base has a baffle defining a receiving space in the baffle and a lid mounted on the baffle to close the receiving space;
the longitudinally moving element of the P-wave detecting device is mounted in the receiving space and comprises
a spring mounted in the receiving space and having a first end securely connected to the base and a second end; and
a weight mounted in the receiving space and connected to the second end of the spring; and
the contacting tab is mounted on an inner wall of the baffle, is mounted in the receiving space and has a boss formed on and protruding from the contacting tab and selectively contacting with the weight.

13. The earthquake alarm as claimed in claim 1, wherein the pendulum has
a hook rod having a first end hung on the casing and a second end provided with an outer thread;
a limiting element screwed with the outer thread on the hook rod; and
a contacting head having a connecting end connected to the second end of the hook rod and being adjacent to the limiting element and a free end opposite to the limiting element, wherein the connecting end has a diameter smaller than that of the free end.
